(19) United States
(12) Patent Application Publication
(10) Pub. No.: US 2025/0214016 A1
(43) Pub. Date: Jul. 3, 2025

(54) GAS FILTER SYSTEM

(71) Applicant: MANN+HUMMEL GmbH, Ludwigsburg (DE)

(72) Inventors: Pascal NEEF, Trossingen (DE); Christoph WITTMERS, Bietigheim-Bissingen (DE); Andreas WEBER, Freiberg (DE); Dennis STARK, Mauer (DE); Mario RIEGER, Ludwigsburg (DE); Markus HANSELMANN, Lauffen (DE); Peter PEKNY, Neuenmarkt (DE); Eva HALLBAUER, Himmelkron (DE); Daniel SCHMID, Sachsenheim (DE); Steffen GERLACH, Nufringen (DE); Friedrich KUPFER, Marklkofen (DE); Philipp HETTKAMP, Steinheim (DE); Johannes GRAD, Simbach (DE); Pedro Miguel PEREIRA MADEIRA, Bietigheim-Bissingen (DE); Dieter WEISS, Gefrees (DE)

(21) Appl. No.: 19/082,349

(22) Filed: Mar. 18, 2025

Related U.S. Application Data
(63) Continuation of application No. PCT/EP2023/066666, filed on Jun. 20, 2023.

(30) Foreign Application Priority Data
Sep. 20, 2022 (EP) 22196487.7

(51) Int. Cl. B01D 46/24; B01D 46/64

(52) U.S. Cl. CPC B01D 46/2411; B01D 46/64; B01D 2271/027

(57) ABSTRACT

A gas filter system comprising an outer filter element having a first filter medium arranged between a first end cap and a second end cap, and an inner filter element having a second filter medium arranged between a third end cap and a fourth end cap, the first filter medium being arrangeable to surround the inner filter medium, wherein the first, second, third and fourth end caps are open.

### CROSS-REFERENCE TO RELATED APPLICATIONS

This application is a continuation application of International Application No. PCT/EP2023/066666 having an international filing date of Jun. 20, 2023, and designating the United States, the international application claiming a priority date of Sep. 20, 2022, based on prior filed European patent Application No. EP 22 196 487.7, the entire contents of the aforesaid international application and the aforesaid European patent application being incorporated herein by reference.

### TECHNICAL FIELD

The present invention refers to a gas filter system including an outer filter element having a first filter medium arranged between a first end cap and a second end cap, and an inner filter element having a second filter medium arranged between a third end cap and a fourth end cap, wherein the first filter medium is arrangeable to surround the second filter medium.

### BACKGROUND

Such a filter system is known from DE 10 2018 215 603 A1.

In some applications, it is required to filter a gas flow with two filter elements. Typically, the gas flows through a first filter element and then, the prefiltered gas flows through a second filter element. The filter elements may be arranged in a common housing. This kind of filter system is for instance used to filter combustion air for large combustion engines, such as for trucks, construction vehicles or the like. Another application is the filtration of air for fuel cells.

From US 2006/0107836 A1 an air filter for internal combustion engines is known. The air filter comprises a round filter element, which is sealingly disposed between an unfiltered air inlet of a housing and a filtered air outlet. In addition, an adsorber element is disposed on an interior wall of the housing such that the adsorber element is arranged within the round filter element.

WO 2015/092681 A1 discloses a multi-layered filter element comprising two layers of filtering material made of pleated paper. The two layers of filtering material are undetachably held together by sealing gaskets made of plastic material in which the paper of the two layers is partially incorporated.

From DE 10 2017 005 797 A1 a filter system having a central tube in a housing is known. A secondary element is arranged inside a filter element and slidable along the central tube. In a first position, the secondary element opens a fluid path through an open area of the central tube; in a second position, the secondary element closes the fluid path through the open area of the central tube.

DE 10 2018 215 603 A1 discloses a gas filter system with a first filter element which surrounds a second filter element. At a first axial end, open end caps of the two filter elements are associated with an outlet for clean air. At a second axial end, the first (outer) filter element has an open end cap and the second (inner) filter element has a closed end cap. The closed end cap of the second (inner) filter element is arranged to close the opening in the end cap of the first (outer) filter element at the second axial end.

It is an object of the invention to facilitate manufacturing and mounting of a gas filter system with two filter elements, which are adapted for joint use.

This object is achieved by a gas filter system according to the invention and use of filter elements according to the invention. Advantageous embodiments are given in the following description.

### SUMMARY

In accordance with the invention, a gas filter system is provided. The gas filter system includes an outer filter element having a first filter medium arranged between a first end cap and a second end cap, and an inner filter element having a second filter medium arranged between a third end cap and a fourth end cap.

The first filter medium is arrangeable to surround the second filter medium. The filter media may be hollow-cylindrical or conical, for example with an essentially circular or oval cross section. The filter media each surround a longitudinal axis. In particular, the filter media may be arranged concentric to a common longitudinal axis. Indications of directions such as radial or axial refer to the longitudinal axis of the filter system. In principle, the first and the third end caps are associated with a first axial end, and the second and fourth end caps are associated with a second axial end.

During use of the gas filter system, a gas flow is typically first directed through the first filter medium of the outer filter element and then through the second filter medium of the inner filter element. Appropriate sealing of the filter elements towards a housing or between the filter elements may be provided as described below.

According to the invention, the first, second, third and fourth end caps are open. The first, second, third and fourth end caps generally have a central opening. Open end caps require less material than closed end caps. Furthermore, simpler tooling may be used to manufacture open end caps. Mounting of the filter elements is also facilitated by the use of open end caps. For example, it is possible to reach into the outer filter element from one axial end while inserting the inner filter element from the other axial end. Further, open end caps allow for visual inspection of the interior of the filter elements prior to and during mounting.

The first end cap of the outer filter element and the third end cap of the inner filter element are sealed against each other. The first end cap may have a (second) sealing section for sealing abutment against the third end cap, for example in the radial direction. Alternatively, the third end cap may have a (second) sealing section for sealing abutment against the first end cap, for example in the radial direction. The second sealing section may be an integral part of the first end cap or the third end cap, respectively.

In general, sealing sections described within the context of this invention are softer than the counterpart against which they seal. For example, a respective sealing section may be made from polyurethane, for example polyurethane foam. The respective counterpart may be made from rigid plastic.

Preferably, the second end cap of the outer filter element and the fourth end cap of the inner filter element are sealed against each other. The second end cap may have a (fourth) sealing section for sealing abutment against the fourth end cap, for example in the radial direction. Alternatively, the fourth end cap may have a (fourth) sealing section for sealing abutment against the second end cap, for example in the radial direction. The fourth sealing section may be an integral part of the second end cap or the fourth end cap, respectively.

The first end cap of the outer filter element may have a first sealing section for sealing abutment against a housing, for example in the axial direction. Alternatively or additionally, the first sealing section may provide radial sealing abutment against the housing. The first sealing section may be an integral part of the first end cap.

The third end cap of the inner filter element may have a third sealing section for sealing abutment against a housing, for example in the axial direction. Alternatively or additionally, the third sealing section may provide radial sealing abutment against the housing. The third sealing section may be an integral part of the third end cap.

The gas filter system further comprises a housing, in which the inner filter element and the outer filter element are arrangeable. In a mounted state, the filter elements are arranged inside the housing. Typically, the housing comprises a first housing part associated with the first end and a second housing part associated with the second end. An inlet may be formed at the first housing part or the second housing part. An outlet is formed for example at the first housing part. The outlet may be in fluid communication with a clean side inside the inner filter element.

The housing may have a central tube, which extends into the inner filter element at the third end cap in a mounted state of the filter system. The central tube provides guidance to the inner filter element and support to the second filter medium.

The housing may have a dome. Preferably, the dome protrudes into the central tube. In other words, the dome and the central tube may overlap each other in the axial direction. The dome may provide guidance during mounting. Undesired movement of the filter elements during operation may be effectively reduced with this design. Upon heavy vibration, the central tube may bear against the dome in order to limit vibrational movement of the filter elements.

The central tube may be held at an axial collar of the housing. This is advantageous for manufacturing the filter housing. A snap fit may be provided between the collar and the central tube.

The third end cap may be sealed against the collar or the central tube of the housing. For example, the third sealing section of the third end cap may sealingly abut the collar or the central tube, for example in the radial direction. In this way, the inside of the inner filter element may be conveniently sealed towards the housing.

The central tube may have a closed bottom face. This allows using the central tube for sealing of the filter elements at the second end.

The fourth end cap may be sealed against the central tube. In particular, the fourth end cap may have a fifth sealing section for sealing abutment against the central tube, for example in the radial direction. The fifth sealing section may be an integral part of the fourth end cap.

The second end cap may be sealed against the central tube. For example, the second end cap may have a sixth sealing section for sealing abutment against the central tube, for example in the radial direction. The sixth sealing section may be an integral part of the fourth end cap.

The outer filter element may have a support tube. The support tube may have a radially inward facing end face, which end face is embedded in the second end cap. The end face of the support tube stiffens the second end cap, thereby sealing of the second end cap against the central tube is facilitated.

The housing may have a first skirt, which protrudes between the second end cap and the fourth end cap. The first skirt provides guidance and support to the filter elements at the second end. The first skirt may exhibit a radially outward facing sealing surface and/or a radially inward facing sealing surface.

The second end cap may be sealed against the first skirt. In particular, the second end cap may have a seventh sealing section for sealing abutment against the first skirt, for example in the radial direction. The seventh sealing section may be an integral part of the second end cap.

The fourth end cap may be sealed against the first skirt. For example, the fourth end cap may have an eighth sealing section for sealing abutment against the first skirt, for example in the radial direction. The eighth sealing section may be an integral part of the fourth end cap.

The housing may have a second skirt, which protrudes into the inner filter element at the fourth end cap. The second skirt provides guidance and support to the inner filter element at the second end. The second skirt may exhibit a radially outward facing sealing surface. The second skirt and the central tube may overlap each other in the axial direction. In particular, the central tube may extend into the second skirt.

The fourth end cap may be sealed against the second skirt. For example, the fourth end cap may have a ninth sealing section for sealing abutment against the second skirt, for example in the radial direction. The ninth sealing section may be an integral part of the fourth end cap.

The first or second skirt are typically formed at the second housing part. Radial sealing of the second and/or fourth end cap against the first and/or second skirt may make the filter elements stick to the second housing part upon opening of the housing. In this way, the filter elements may be conveniently removed and exchanged. For mounting, the filter elements may be held at the first and/or second skirt. Thus, common mounting of the filter elements and the second housing part is enabled.

The first filter medium or the second filter medium, for example the second filter medium of the inner filter element, may have gas-adsorbing properties and for example contains activated carbon. Typical harmful gases are SO₂, NOₓ and NH₃.

The first filter medium or the second filter medium, for example the first filter medium of the outer filter element, may be made with cellulose.

The first filter medium and/or the second filter medium may be pleated.

End caps, which have at least one sealing section, may be made from polyurethane, for example polyurethane foam. For example, an end cap which has at least one sealing section, is monolithic with its sealing section(s).

An end cap, against which a sealing section may abut, may be made from rigid plastic. A rigid plastic end cap may be glued to the respective first or second filter medium.

The invention also relates to the use of an outer filter element and/or an inner filter element in a gas filter system according to the invention, as described above. The gas filter system may be used for cathode air filtration of a fuel cell in an electric vehicle.

### BRIEF DESCRIPTION OF DRAWINGS

Other advantages and features of the invention will be appreciated from the following description of exemplary embodiments of the invention with reference to the accompanying figures of the drawings, which show significant details. The individual features, as described above or explained below, may each be implemented individually or implemented together in any useful combination in variants of the invention.

FIG. 1 shows a first embodiment of a gas filter system according to the invention, the gas filter system comprising an outer filter element, an inner filter element and a housing, in a schematic sectional view.

FIG. 2 shows the outer filter element of the gas filter system of FIG. 1, in a schematic sectional view.

FIG. 3 shows the inner filter element of the gas filter system of FIG. 1, in a schematic sectional view.

FIG. 4 shows a first end of the filter system of FIG. 1 in an enlarged view.

FIG. 5 shows a second end of the filter system of FIG. 1 in an enlarged view.

FIG. 6 shows a second end of a second embodiment of a filter system according to the invention in a schematic sectional view.

FIG. 7 shows a first end of a third embodiment of a filter system according to the invention in a schematic sectional view.

FIG. 8 shows a first end of a fourth embodiment of a filter system according to the invention in a schematic sectional view.

FIG. 9 shows a second end of the fourth embodiment of the filter system according to the invention, in a schematic sectional view.

FIG. 10 shows a first end of a fifth embodiment of a filter system according to the invention in a schematic sectional view.

FIG. 11 shows a second end of the fifth embodiment of the filter system according to the invention, in a schematic sectional view.

FIG. 12 shows a second end of a sixth embodiment of a filter system according to the invention in a schematic sectional view.

### DETAILED DESCRIPTION

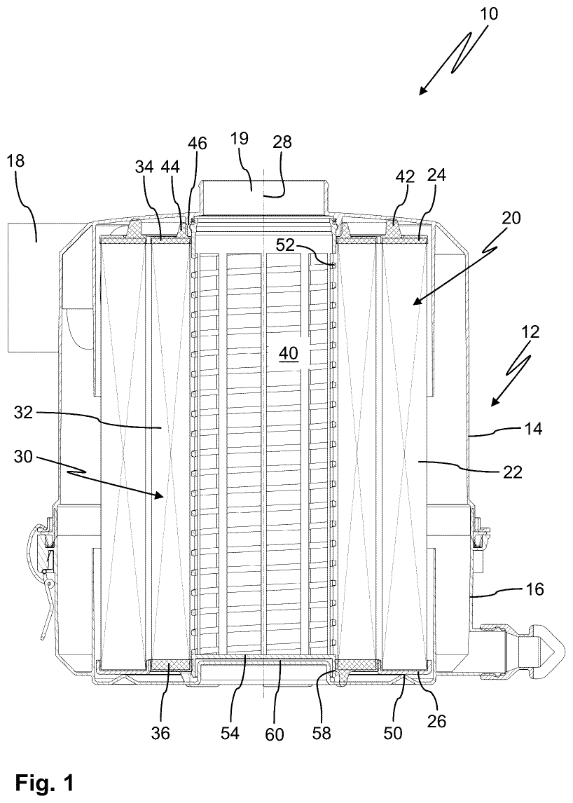

FIG. 1 shows a gas filter system 10. The filter system 10 comprises a housing 12. The housing 12 has a first housing part 14 and a second housing part 16, which are attachable to each other. An inlet 18 allows gas to enter the housing 12. Here the inlet 18 is formed at the first housing part 14. An outlet 19 for filtered gas is also formed at the first housing part 14. The housing parts 14, 16 may be made from metal and/or rigid plastic.

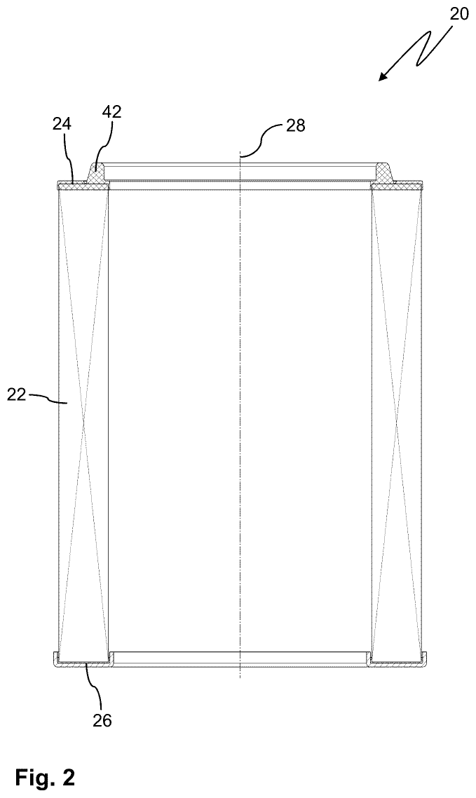

The filter system 10 further comprises an outer filter element 20, see also FIG. 2. The outer filter element 20 comprises a first filter medium 22. The first filter medium 22 is contained between a first end cap 24 and a second end cap 26. The first filter medium 22 surrounds a longitudinal axis 28 in a circular manner. The first filter medium 22 may be made from pleated cellulose paper.

The filter system 10 further comprises an inner filter element 30, see also FIG. 3. The inner filter element 30 comprises a second filter medium 32. The second medium 32 is contained between a third end cap 34 and a fourth end cap 36. The second filter medium 32 also surrounds the longitudinal axis 28 in a circular manner. The second filter medium 32 may contain activated carbon in order to achieve gas-adsorbing properties.

The inner filter element 30 is arranged inside the outer filter element 20. Both filter elements 20, 30 are arranged inside the housing 12. Here, the first and second filter medium 22, 32 are concentric to one another and to the longitudinal axis 28.

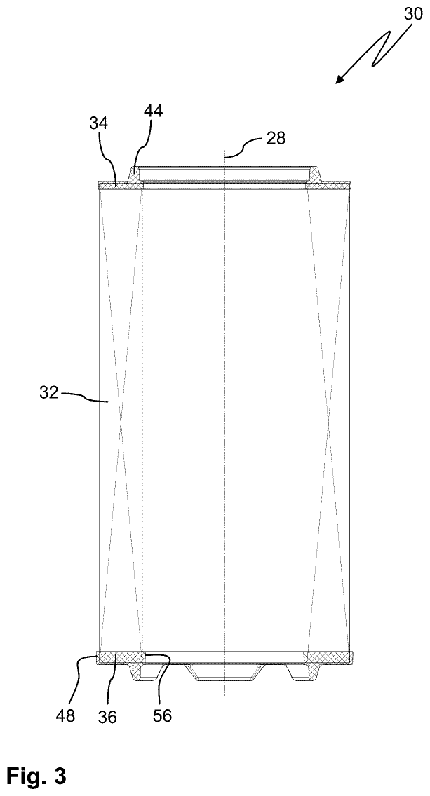

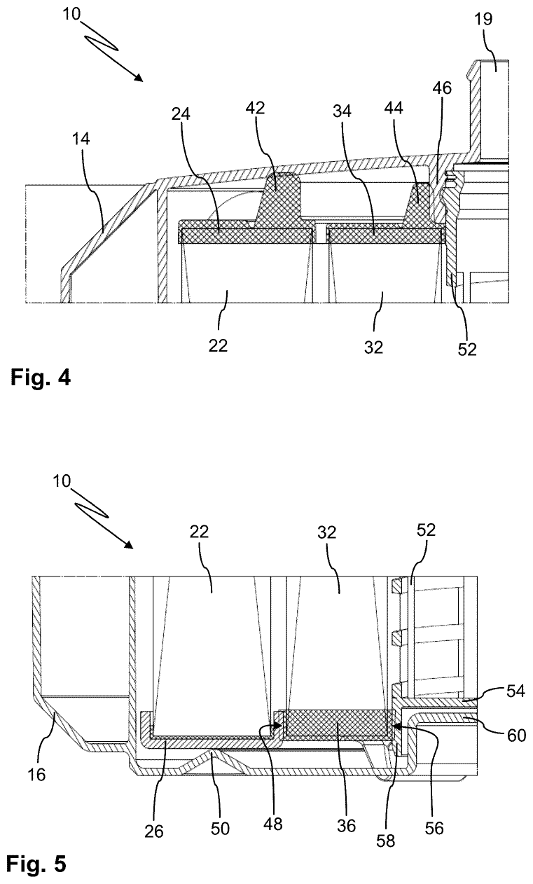

At a first end of the filter system 10, the first end cap 24 is arranged to surround the third end cap 34, see also FIG. 4. The first end cap 24 and the third end cap 34 each have a central opening, see also FIG. 2 and FIG. 3, respectively. The outlet 19 is in fluid communication with a clean side 40 within the inner filter element 30, cf. FIG. 1.

A first sealing section 42 axially protrudes from the first end cap 24. The first sealing section 42 sealingly abuts the first housing part 14 in the axial direction. Here, the first end cap 24 with the first sealing section 42 is integrally formed from polyurethane foam.

A third sealing section 44 axially protrudes from the third end cap 34. The third sealing section 44 sealingly abuts the first housing part 14 in the radial direction. In particular, the third sealing section 44 sealingly rests against a collar 46, which axially protrudes into the housing 12 at the outlet 19. Here, the third end cap 34 and the third sealing section 44 are integrally formed from polyurethane foam.

At the second end of the filter system 10, the second end cap 26 is arranged to surround the fourth end cap 36, see also FIG. 5. The second end cap 26 and the fourth end cap 36 each have a central opening, see also FIG. 2 and FIG. 3, respectively.

The second end cap 26 and the fourth end cap 36 are sealed against each other. In the depicted embodiment, a radial sealing is established. The fourth end cap 36, at its outer perimeter, has a fourth sealing section 48. The fourth sealing section 48 sealingly abuts the second end cap 26 in the radial direction.

The second end cap 26 may be made from rigid plastic and, for example, is glued to the first filter medium 22. The second housing part 16 may have a bottom support projection 50, which bears against the second end cap 26 in the axial direction.

A central tube 52 of the housing 12 is held at the axial collar 46. The central tube 52 extends through the opening of the third end cap 34 beyond the fourth end cap 36. The central tube 52 may be made from rigid plastic. In the first embodiment, the central tube 52 has a closed bottom face 54, see in particular FIG. 1 and FIG. 5.

In the first embodiment, the fourth end cap 36 is sealed against the central tube 52. A fifth sealing section 56 is formed at the opening of the fourth end cap 36. The fifth sealing section 56 sealingly abuts the central tube 52 in the radial direction. The central tube 52 may have an annular protrusion 58, which is arranged beyond the closed bottom face 54, as seen from the first end with the outlet 19. At the annular protrusion 58, a radially outward facing sealing surface for abutment of the fifth sealing section 56 is formed.

The fourth end cap 36 with the fourth sealing section 48 and the fifth sealing section 56 may be integrally formed from polyurethane foam. In other words, the fourth end cap 36 with its sealing sections 48, 56 may be a monolitic part.

The housing 12 may have a dome 60, see FIG. 1 and FIG. 5. Here, the dome 60 is formed at the second housing part 16, which may be a removable cover. The dome 60 extends towards the inside of the inner filter element 30. In particular, the dome 60 extends into the central tube 52 axially at the annular protrusion 58. In other words, the central tube 52 and the dome 60 overlap each other in the axial direction. The closed bottom face 54 of the central tube 52 is arranged slightly above the dome 60.

The second end cap 26 and the fourth end cap 36 may have a circular cross section. In order to install the filter elements 20, 30 in a defined position in a circumfererential direction, the end caps 26, 36 and the housing 12 may have a radially directed projection-receiver arrangement. For example, a radially outward directed projection on the fourth end cap 36 may project into an indentation in the second end cap 26. Likewise, an outwardly directed projection on the second end cap 26 may project into a recess in an inner wall of the housing 12 or a projection on the housing inner wall may project into a recess in the outer circumference of the second end cap 26.

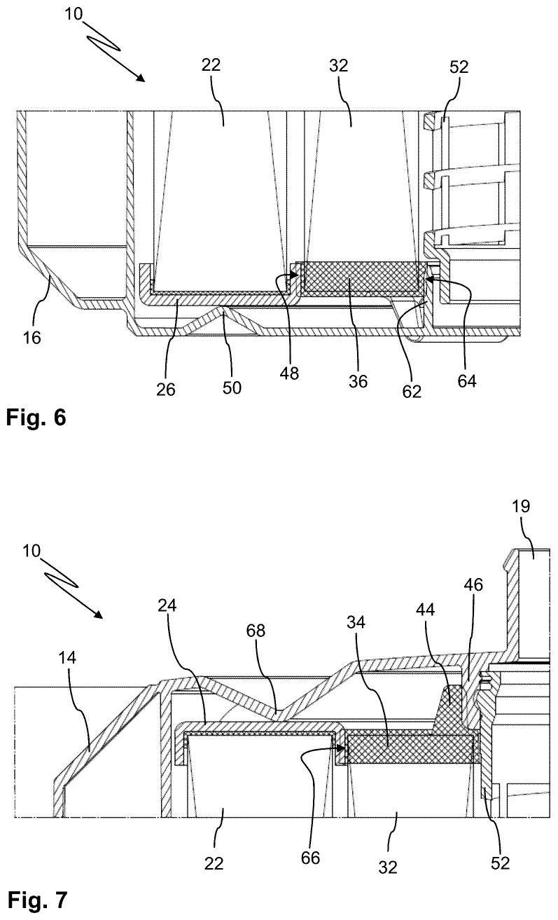

A second embodiment of the gas filter system 10, a first end of which is partially depicted in FIG. 6, corresponds substantially to the first embodiment of the gas filter system 10, cf. FIGS. 1-5, and the description above.

In the second embodiment, a second skirt 62 is formed at the second housing part 16. The second skirt 62 protrudes into the inner filter element 30 at the fourth end cap 36. The central tube 52 and the second skirt 62 overlap each other in the axial direction. In particular, the central tube 52 extends into the second skirt 62 with its end section, which may have a smaller diameter than a middle section of the central tube 52.

In the second embodiment, the fourth end cap 36 is sealed against the second skirt 62. A ninth sealing section 64 is formed at the opening of the fourth end cap 36. The ninth sealing section 64 sealingly abuts the second skirt 62 in the radial direction.

A third embodiment of the gas filter system 10, a second end of which is partially depicted in FIG. 7, corresponds substantially to the first embodiment of the gas filter system 10, cf. FIGS. 1-5, and the description above.

In the third embodiment, the first end cap 24 and the third end cap 34 are sealed against each other. Here, a radial sealing is established. The third end cap 34 has a second sealing section 66. The second sealing section 66 sealingly abuts the first end cap 24 in the radial direction.

The third end cap 34 with the second sealing section 66 and the third sealing section 44 may be integrally formed from polyurethane foam. In other words, the third end cap 34 with its sealing sections 44, 66 may be a monolitic part.

The first end cap 24 may be made from rigid plastic and is, for example, glued to the first filter medium 22. The first housing part 14 may have a top support projection 68, which bears against the first end cap 24 in the axial direction.

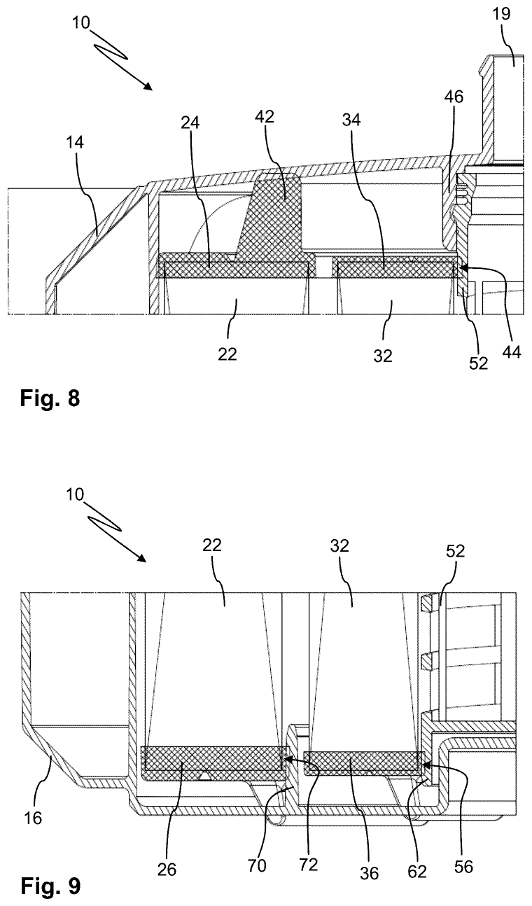

A fourth embodiment of the gas filter system 10, a first and second end of which are partially depicted in FIG. 8 and FIG. 9, corresponds in its basic structure to the first embodiment of the gas filter system 10, cf. FIGS. 1-5, and the description above.

In the fourth embodiment, the third end cap 34 of the inner filter element 30 is sealed against the central tube 52, see FIG. 8. A third sealing section 44 radially delimits the opening of the third end cap 34. The third sealing section 44 sealingly abuts the central tube 52 of the housing 12 in the radial direction. Here, the third end cap 34 and the third sealing section 44 are integrally formed from polyurethane foam.

As in the first embodiment, also in the fourth embodiment the fourth end cap 36 of the inner filter element 30 is sealed against the central tube 52 via the fifth sealing section 56, see FIG. 9.

However, in the fourth embodiment a first skirt 70 of the second housing part 16 axially protrudes between the second end cap 26 and the fourth end cap 36. The second end cap 26 is sealed against the first skirt 70. A seventh sealing section 72 radially delimits the opening of the second end cap 26. The seventh sealing section 72 sealingly abuts the first skirt 70 in the radial direction. Here, the second end cap 26 and the seventh sealing section 72 are integrally formed from polyurethane foam.

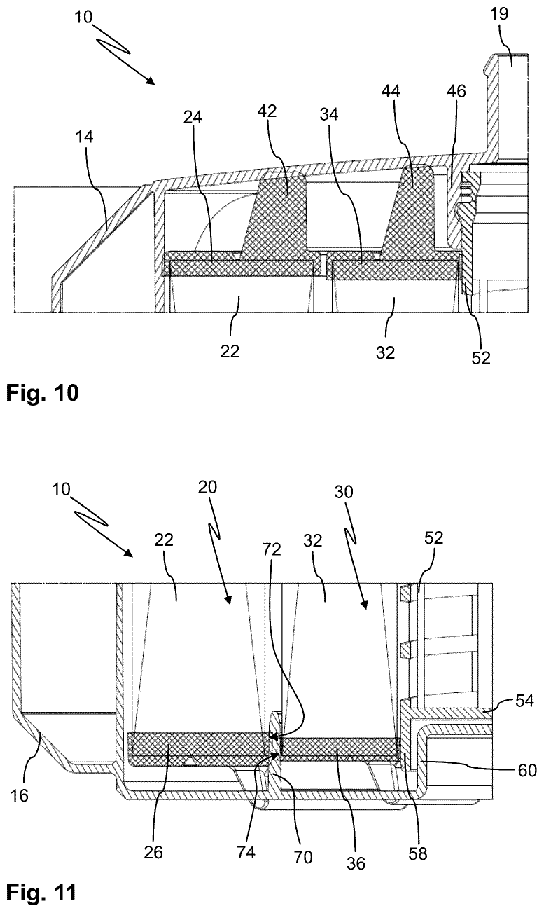

A fifth embodiment of the gas filter system 10, a first and second end of which are partially depicted in FIG. 10 and FIG. 11, corresponds substantially to the fourth embodiment of the gas filter system 10, cf. FIG. 8 and FIG. 9, and the description above.

In the fifth embodiment, an axial sealing between the third end cap 34 and the first housing part 14 is established, see FIG. 10. A third sealing section 44 axially protrudes from the third end cap 34. The third sealing section 44 sealingly abuts the first housing part 14 in the axial direction. Here, the third end cap 34 and the third sealing section 44 are integrally formed from polyurethane foam.

As in the first and fourth embodiments, also in the fifth embodiment axial sealing between the first end cap 24 and the first housing part 14 is established via the first sealing section 42.

As in the fourth embodiment, also in the fifth embodiment radial sealing between the second end cap 26 and the first skirt 70 is established via the seventh sealing section 72. However, in the fifth embodiment, also the fourth end cap 36 is sealed against the first skirt 70. An eighth sealing section 74 is formed at the outer perimeter of the fourth end cap 36. The eighth sealing section 74 sealingly abuts the first skirt 70 in the radial direction. Here, the fourth end cap 36 and the eighth sealing section 74 are integrally formed from polyurethane foam.

Since radial sealing is established at the second end (second and fourth end caps 26, 36), while axial sealing is established at the first end (first and third end caps 24, 34), the filter elements 20, 30 will be held at the second housing part 16, when the housing 12 is opened. This facilitates servicing the gas filter system and replacing the filter elements 20, 30.

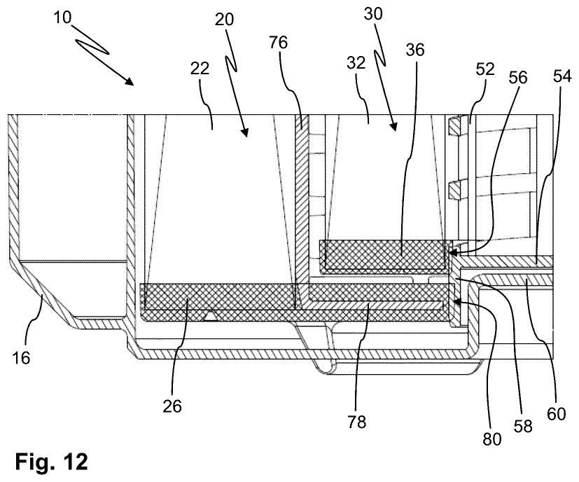

A sixth embodiment of the gas filter system 10, a second end of which is partially depicted in FIG. 12, corresponds substantially to the first embodiment of the gas filter system 10, cf. FIGS. 1-5, or the fourth embodiment, cf. FIG. 8 and FIG. 9, and the description above.

As in the first or fourth embodiments, also in the sixth embodiment radial sealing between the fourth end cap 36 and the central tube 52 is established via the fifth sealing section 56. Note that the central tube 52 may be circumferentially closed also slightly above the closed bottom face 54 for sealing abutment of the fifth sealing section 56.

In the sixth embodiment, the second end cap 26 of the outer filter element 20 is sealed against the central tube 52. The outer filter element 20 is longer (in axial direction) than the inner filter element 30. The outer filter element 20 may comprise a support tube 76. Here, the support tube 76 has an end face 78, which extends radially inwardly at the second end cap 26. In particular, the end face 78 is embedded in the second end cap 26. A sixth sealing section 80 radially delimits the opening in the second end cap 26. Note that the sixth sealing section 80 is arranged radially to the inside of the end face 78. The sixth sealing section 80 sealingly abuts the central tube 52 in the radial direction. In particular, the sixth sealing section 80 may rest against the annular protrusion 58 of the central tube 52. Here, the second end cap 26 and the sixth sealing section 80 are integrally formed from polyurethane foam.

### REFERENCE NUMBERS

Gas filter system 10
Housing 12
First housing part 14
Second housing part 16
Inlet 18
Outlet 19
Outer filter element 20
First filter medium 22
First end cap 24
Second end cap 26
Longitudinal axis 28
Inner filter element 30
Second filter medium 32
Third end cap 34
Fourth end cap 36
Clean side 40
First sealing section 42
Third sealing section 44
Collar 46
Fourth sealing section 48
Bottom support projection 50
Central tube 52
Bottom face 54
Fifth sealing section 56
Protrusion 58
Dome 60
Second skirt 62
Ninth sealing section 64
Second sealing section 66
Top support projection 68
First skirt 70
Seventh sealing section 72
Eighth sealing section 74
Support tube 76
End face 78
Sixth sealing section 80

1. A gas filter system comprising
an outer filter element having a first filter medium arranged between a first end cap and a second end cap; and
an inner filter element having a second filter medium arranged between a third end cap and a fourth end cap;
the first filter medium being arrangeable to surround the inner filter medium;
wherein the first, second, third and fourth end caps are open.

2. The gas filter system according to claim 1, wherein the first end cap of the outer filter element and the third end cap of the inner filter element are sealed against each other.

3. The gas filter system according to claim 6, wherein the third end cap has a second sealing section for sealing abutment against the first end cap in a radial direction.

4. The gas filter system according to claim 1, wherein the second end cap of the outer filter element and the fourth end cap of the inner filter element are sealed against each other.

5. The gas filter system according to claim 7, wherein the fourth end cap has a fourth sealing section for sealing abutment against the second end cap in the radial direction.

6. The gas filter system according to claim 1, wherein the first end cap of the outer filter element has a first sealing section for sealing abutment against a housing in an axial direction.

7. The gas filter system according to claim 3, wherein the third end cap of the inner filter element has a third sealing section for sealing abutment against a housing.

8. A gas filter system according to claim 1, further comprising a housing, in which the outer filter element and the inner filter element are arrangeable.

9. The gas filter system according to claim 8, wherein the housing has a central tube that extends into the inner filter element at the third end cap.

10. The gas filter system according to claim 9, wherein the housing has a dome that protrudes into the central tube.

11. The gas filter system according to claim 9, wherein the central tube is held at an axial collar of the housing.

12. The gas filter system according to claim 11, wherein the third end cap is sealed against the collar or the central tube.

13. The gas filter system according to claim 9, wherein the fourth end cap has a fifth sealing section for sealing abutment against the central tube in a radial direction.

14. The gas filter system according to claim 13, wherein the second end cap has a sixth sealing section for sealing abutment against the central tube in a radial direction.

15. The gas filter system according to claim 14, wherein the outer filter element has a support tube, and wherein the support tube has a radially inward facing end face that is embedded in the second end cap.

16. The gas filter system according to claim 8, wherein the housing has a first skirt that protrudes between the second end cap and the fourth end cap.

17. The gas filter system according to claim 16, wherein the second end cap has a seventh sealing section for sealing abutment against the first skirt in a radial direction.

18. The gas filter system according to claim 16, wherein the fourth end cap has an eighth sealing section for sealing abutment against the first skirt in a radial direction.

19. The gas filter system according to claim 8, wherein the housing has a second skirt that protrudes into the inner filter element at the fourth end cap.

20. The gas filter system according to claim 19, wherein the fourth end cap has a ninth sealing section for sealing abutment against the second skirt in a radial direction.

21. Use of the outer filter element and/or the inner filter element in the gas filter system according to claim 1.
